(19) United States
(12) Patent Application Publication
(10) Pub. No.: US 2026/0200355 A1
(43) Pub. Date: Jul. 16, 2026

(54) CHARGING SYSTEM

(71) Applicant: EVX Australia Pty Ltd, Frenchs Forest, NSW (AU)

(72) Inventors: Sean MCGINTY, Mosman (AU); Kevin MOONEY, Mosman (AU)

(21) Appl. No.: 19/139,294

(22) PCT Filed: Dec. 15, 2023
(86) PCT No.: PCT/AU2023/051307

§ 371 Date: Jun. 13, 2025

(30) Foreign Application Priority Data
Dec. 15, 2022 (AU) 2022903861

(51) Int. Cl. B60L 53/31; B60L 53/16; B60L 53/30; B60L 53/66

(52) U.S. Cl. CPC B60L 53/31; B60L 53/16; B60L 53/305; B60L 53/665; B60L 2270/34

(57) ABSTRACT

Embodiments generally relate to a charging system for charging a device via a utility pole, the utility pole comprising a power supply, and to methods related to such charging systems. An example charging system comprises: a body mountable to the utility pole; a power module carried by the body and connectable to the power supply of the utility pole, the power module may have a utility meter for measuring power consumed by the power module from the power supply; and a charging module carried by the body and in electrical communication with the power module, the charging module may be operable to provide power received from the power module to the device.

### TECHNICAL FIELD

The present disclosure relates, generally, to charging systems, and, more particularly, to charging systems for charging a device via a utility pole.

### BACKGROUND

With the prevalence of battery-powered devices in the modern world, it is undesirable for the battery charge of these devices to become depleted when a means for charging the batteries is unavailable. For example, the battery charge of a user's device may become depleted while the user is in public and far from a suitable charging location such as their home or workplace.

Electric vehicles are subject to the above issues, however, publicly accessible electric vehicle charging stations attempt to address these issues. These electric vehicle charging stations also allow users who do not have driveway space in their homes in which to install an electric vehicle charger to have access to electric vehicle charging and therefore still be able to own an electric vehicle. However, these electric vehicle charging stations are not readily available and may be far from the homes of users, thereby being inconvenient for users who may prefer to drive petrol vehicles for this reason, which contribute more to greenhouse gas emissions.

To allow electric vehicle charging stations to be located closer to a larger number of user homes, existing infrastructure may be used. An electric vehicle charger may be connected to a power supply of this infrastructure, however, a switchboard with a utility meter may be required by law to be connected to the power supply and to the electric vehicle charger. Switchboards may be required by law to be reachable by a technician without the use of a ladder, however, switchboards are generally large and cause visual pollution when located closer to the ground and near the electric vehicle charger.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

In an aspect of the present disclosure, there is provided a charging system for charging a device via a utility pole, the utility pole comprising a power supply, the charging system comprising: a body mountable to the utility pole; a power module carried by the body and connectable to the power supply of the utility pole, the power module having a utility meter for measuring power consumed by the power module from the power supply; and a charging module carried by the body and in electrical communication with the power module, the charging module being operable to provide power received from the power module to the device.

The charging system may further comprise a mounting bracket mountable to the utility pole, wherein the body is mountable to the mounting bracket for mounting the body to the utility pole. The mounting bracket may comprise at least one pin extending away from an operatively top portion of the mounting bracket, and the body may define at least one receptacle proximate an operatively top portion of the body for receiving the at least one pin to mount the body to the mounting bracket. The mounting bracket may comprise a pair of spaced pins extending away from the operatively top portion of the mounting bracket, and the body may define a pair of spaced receptacles proximate the operatively top portion of the body for receiving the pair of pins to mount the body to the mounting bracket.

The at least one receptacle may be defined in an operatively rear portion of the body. The at least one pin of the mounting bracket and the at least one receptacle of the body may be configured such that a total mass of the body is supportable by the mounting bracket when the at least one pin is received in the at least one receptacle. The mounting bracket may comprises a recessed portion such that the mounting bracket is configured to contact the utility pole at two spaced portions of the utility pole. The body and the mounting bracket may be elongate. A width of the mounting bracket may be less than a width the body.

The charging system may further comprise a pair of panels connectable to the body, each of the pair of panels comprising a series of vents for providing ventilation to the power module and the charging module. The vents may be arranged to prevent water ingress into the body. The vents may be arranged such that the vents are hidden from an operatively front view of the body. The pair of panels are removably connectable to the body. The pair of panels may be arranged to obscure the mounting bracket. Each panel may be configured to extend about a portion of the utility pole to obscure the mounting bracket.

The charging system may further comprise an antenna mounted on an external surface of the body, the antenna being in communication with the charging module for communication between the charging module and a server via a wide area network. The charging module may comprise a charging meter for measuring power provided by the charging module to the device, the charging meter being in communication with the antenna for transmitting an indication to the server of a measure of power provided to the device via the wide area network. The charging system may further comprise an application installable on a user device for communication between the user device and the charging module via the server and the antenna over the wide area network, the application configured to effect electronic payment between a user and an operator of the charging module based on the indication of the power outputted by the charging module received by the server. The utility meter of the power module may be in communication with the antenna for communication between the utility meter and an operator of the utility meter via the wide area network for transmitting an indication of the power consumed from the power supply by the power module to the operator via the wide area network.

The body may comprise a first portion and a second portion spaced from the first portion, wherein the first portion carries the power module and the second portion carries the charging module. The first portion and the second portion may be spaced by a plate defining at least one through hole for connecting the charging module to the power module. The charging system may further comprise a pair of covers connectable to the body for covering the first portion and the second portion. The covers may be hingedly connectable to the body.

A total length of the body may be between about 500 millimetres and about 2500 millimetres. The body may be mountable to the utility pole such that the power module is less than about 2000 millimetres above ground level and such that the charging module is at least about 800 millimetres above ground level. The power supply of the utility pole may comprise a three-phase AC power supply, and the charging module may be operable to provide three-phase AC power received from the power module to the device.

The charging system may further comprise at least one charging socket for providing power to the device. The device may be an electric vehicle, and the at least one charging socket may be operable to provide power to the electric vehicle.

In another aspect of the present disclosure, there is provided a method of installing a charging system for charging a device to a utility pole comprising a power supply, the method comprising: mounting a mounting bracket of the charging system to the utility pole, the mounting bracket comprising at least one pin extending away from an operatively top portion of the mounting bracket; mounting a body of the charging system to the mounting bracket by inserting the at least one pin of the mounting bracket into at least one receptacle defined proximate an operatively top portion of the body, wherein the body carries: a power module connectable to the power supply of the utility pole, the power module having a utility meter for measuring power consumed by the power module from the power supply, and a charging module in electrical communication with the power module, the charging module being operable to provide power received from the power module to the device; and connecting the power supply of the utility pole to the power module of the charging system.

The method may further comprise connecting a pair of panels of the charging system to the body, each of the pair of panels comprising a series of vents for providing ventilation to the power module and the charging module. The mounting the mounting bracket to the utility pole may comprise fastening the mounting bracket to the utility pole.

The mounting bracket may comprise a pair of spaced pins extending away from the operatively top portion of the mounting bracket. A pair of spaced receptacles may be defined proximate the operatively top portion of the body. The mounting the body to the mounting bracket may comprise inserting the pair of spaced pins of the mounting bracket into the pair of spaced receptacles of the body.

The mounting the body to the mounting bracket may comprise fastening the body to the mounting bracket. The fastening the body to the mounting bracket may comprise fastening an operatively bottom portion of the body to an operatively bottom portion of the mounting bracket.

The body may comprise a first portion and a second portion spaced from the first portion, wherein the first portion carries the power module and the second portion carries the charging module, and the method may further comprise connecting a pair of covers to the body for covering the first portion and the second portion.

The method may further comprise connecting at least one charging socket to the charging module for providing power to the device. The utility pole may further comprise a power cable connected to the power supply, and the connecting the power supply to the power module may comprise connecting the power cable to the power module. The method may further comprise connecting an earthing cable to the charging module for earthing the charging module and the power module.

In another aspect of the present disclosure, there is provided a charging system for charging a device via a utility pole, the utility pole comprising a power supply, the charging system comprising: a mounting bracket mountable to the utility pole, the mounting bracket comprising at least one pin extending away from an operatively top portion of the mounting bracket; a body mountable to the mounting bracket and defining at least one receptacle proximate an operatively top portion of the body, the body being mountable to the mounting bracket by insertion of the at least one pin of the mounting bracket into the at least one receptacle; and a charging module carried by the body and connectable to the power supply of the utility pole, the charging module being operable to provide power received from the power supply to the device.

In another aspect of the present disclosure, there is provided a method of installing a charging system for charging a device to a utility pole comprising a power supply, the method comprising: mounting a mounting bracket of the charging system to the utility pole, the mounting bracket comprising at least one pin extending away from an operatively top portion of the mounting bracket; mounting a body of the charging system to the mounting bracket by inserting the at least one pin of the mounting bracket into at least one receptacle defined proximate an operatively top portion of the body, wherein the body carries a charging module connectable to the power supply of the utility pole, the charging module being operable to provide power received from the power supply to the device; and connecting the power supply of the utility pole to the charging module of the charging system.

It will be understood that the charging system and method of paragraphs [0020] and [0021] may be combined with any relevant system or method features defined above.

In another aspect of the present disclosure, there is provided a mounting bracket for mounting a body of a charging system for charging a device to a utility pole, the mounting bracket comprising: an elongate body having a first end and a second end; at least one pin extending away from the first end of the elongate body, the at least one pin being configured to support a total mass of the body of the charging system; and a recessed portion formed between the first end and the second end of the elongate body such that the elongate body is configured to contact the utility pole at two spaced portions of the utility pole.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments will now be described by way of example only with reference to the accompanying drawings in which:

FIG. 1 shows a top, front perspective view of an embodiment of a charging system for charging a device via a utility pole;

FIG. 2 shows an exploded, top, front perspective view of the charging system shown in FIG. 1, showing a body, a mounting bracket and a pair of panels of the charging system;

FIG. 3 shows a rear view of the charging system shown in FIGS. 1 and 2;

FIG. 4 shows a side view of the charging system shown in FIGS. 1-3;

FIG. 5 shows a top view of the charging system shown in FIGS. 1-4;

FIG. 6 shows an enlarged perspective view of an interior of the body shown in FIGS. 1-5 with an electric vehicle charging socket fixed to the body;

FIG. 7A shows a top, front perspective view of an embodiment of a mounting bracket for mounting a body of the charging system shown in FIGS. 1-5 to a utility pole;

FIG. 7B shows a bottom, rear perspective view of the mounting bracket shown in FIG. 7A;

FIG. 7C shows a rear view of the mounting bracket shown in FIGS. 7A and 7B;

FIG. 7D shows a bottom view of the mounting bracket shown in FIGS. 7A-7C;

FIG. 8 shows an electrical schematic of the components of the charging system shown in FIGS. 1-5;

FIG. 9 shows a network schematic including the charging system shown in FIGS. 1-5 in communication with a server and a meter operator via a wide area network;

FIG. 10 shows a flowchart of an embodiment of a method of installing the charging system shown in FIGS. 1-5 to a utility pole;

FIG. 11 shows a flowchart of another embodiment of a method of installing the charging system shown in FIGS. 1-5 to a utility pole;

FIGS. 12A and 12B show a top, perspective view of the mounting bracket shown in FIGS. 7A-7D being fastened to a utility pole using screws and a flexible fastener, respectively, as a part of the method shown in FIGS. 10 and 11;

FIGS. 13A and 13B show a side view of the charging system shown in FIGS. 1-5 being mounted to the mounting bracket shown in FIGS. 7A-7D and 12A as a part of the method shown in FIGS. 10 and 11;

FIGS. 13C and 13D show enlarged, perspective views of respective sections of FIG. 13B encircled by the circles B and C, respectively;

FIG. 14 shows a top, perspective view of a pair of panels being connected to the charging system shown in FIGS. 1-5 in addition to the method shown in FIGS. 10 and 11; and

FIG. 15 shows a side view of the charging system shown in FIGS. 1-5 after the charging system is installed to a utility pole.

### DESCRIPTION OF EMBODIMENTS

In the drawings, reference numeral 10 designates a charging system 10 for charging a device via a utility pole 14 comprising a power supply. The charging system 10 comprises a body 16 mountable to the utility pole 14 and a power module 18 carried by the body 16 and connectable to the power supply of the utility pole 14. The power module 18 has a utility meter 20 for measuring power consumed by the power module 14 from the power supply. The charging system 10 further comprises a charging module 22 carried by the body 16 and in electrical communication with the power module 18, the charging module 22 being operable to provide power received from the power module 14 to the device.

In some embodiments, the power module 18 may be owned and/or managed and/or accessible by an operator of the utility meter 20, and the charging module 22 may be owned and/or managed and/or accessible by an operator of the charging module 22 being separate to the operator of the utility meter 20. It will be understood that the device described throughout the current specification is an electric vehicle, however, it will be understood that other devices such as mobile computing devices, digital cameras, drones, and other portable electronic devices may be chargeable in some embodiments of the charging system 10.

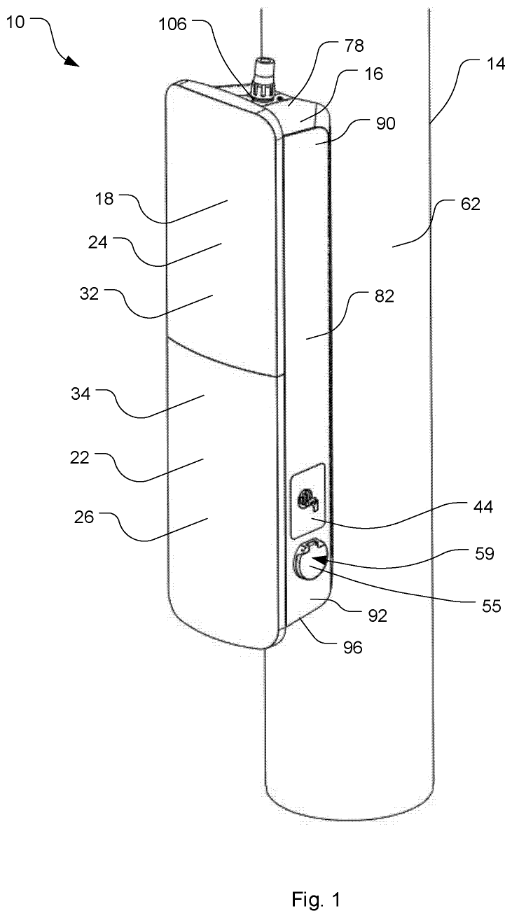

Referring to FIGS. 1-5, the body 16 comprises a first portion 24 carrying the power module 18 and a second portion 26 spaced from the first portion 24 carrying the charging module 22. The first portion 22 and the second portion 24 are spaced by a plate 28 defining a pair of through holes 30 for electrically connecting the charging module 22 to the power module 18. For example, the through holes 30 allow for the passage of conductive cables or wires (not shown) connecting the power module 18 and the charging module 22. It will be understood that in other embodiments, only a single through hole 30 may be defined in the plate 28.

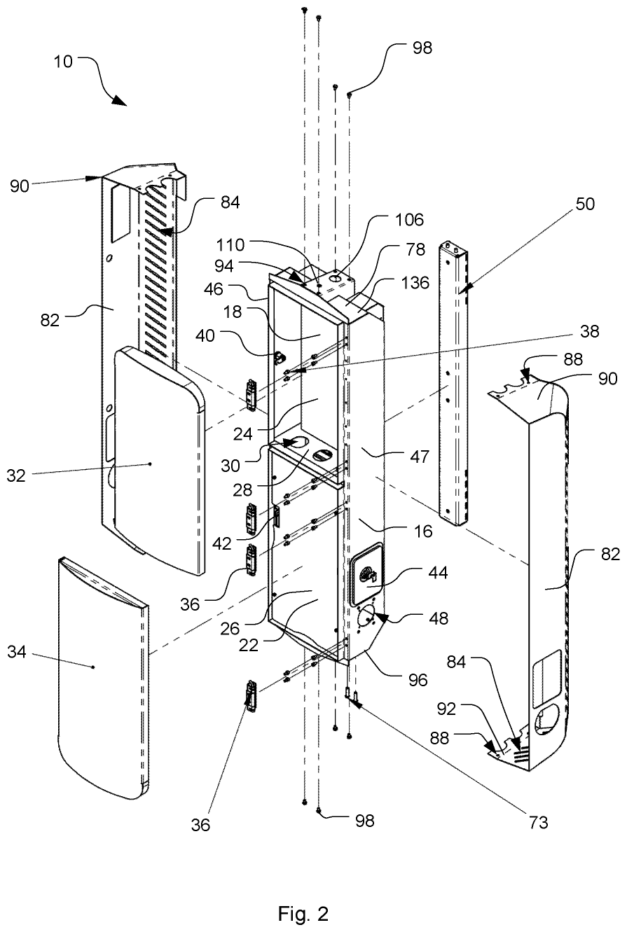

In the illustrated embodiments, the charging system 10 comprises a pair of covers 32, 34 connectable to the body 16 for covering the first portion 24 and the second portion 26. The pair of covers 32, 34 are hingedly connectable to the body 16 by fixing a pair of concealed hinges 36 to the body 16 for each cover 32, 34 using screws 38 (FIG. 2). The covers 32, 34 are lockable in a closed position using respective locking mechanisms 40, 42 which are configured to move between a locked and unlocked position by using a respective key (not shown). In this embodiment, a key for unlocking the locking mechanism 40 of the cover 32 and accessing the power module 18 may be kept by an authorised person, and a key for unlocking the locking mechanism 42 of the cover 34 and accessing the charging module 22 may be kept by a different authorised person. By implementing the covers 32, 34 and/or the locking mechanisms 40, 42, the power module 18 and the charging module 22 may be secured and accessible by different personnel while still being carried by a single body 16.

The body 16 further comprises RFID readers 44 connected to the charging module 22 and disposed on respective side portions 46, 47 of the body 16 for access by a user. The body 16 also defines a through hole 48 in each side portion 46, 47 of the body 16 for installing a socket, for example, an electric vehicle charging socket 49 for providing power to an electric vehicle (FIG. 6). The electric vehicle charging socket 49 is screwed into the body 16 using screws 45 from an interior surface 51 of the body 16 at each of the side portions 46, 47, and the through hole 48 on each of the side portions 46, 47 is used to access the electric vehicle charging socket 49 using an electric vehicle charging cable (not shown).

The body 16 further comprises a hinged socket cover 55 connectable to the body 16 using screws (not shown) for covering the electric vehicle charging socket 49 and being movable between a closed position 59 (FIGS. 1, 4 and 14) and an open position (not shown). In some embodiments, the socket cover 55 is resiliently biased towards the closed position 59 in order to protect the charging socket 49 from the ingress of moisture and other environmental elements while the charging socket 49 is not in use.

The body 16 is elongate in the illustrated embodiment and has a total length of between about 500 millimetres and about 2500 millimetres. Typically, the body 16 has a total length of between about 700 millimetres and about 1300 millimetres. The body 16 has a total width of between about 200 millimetres and about 500 millimetres and, typically, between about 250 millimetres and about 400 millimetres. The body 16 is mountable to the utility pole 14 such that the power module 18 is less than about 2000 millimetres above ground level and such that the charging module 22 is at least about 800 millimetres above ground level. In particular, the body 16 is mountable to the utility pole 14 such that an operative top of the power module 18 is less than about 2000 millimetres above ground level and such that an operative bottom of the charging module 22 is at least about 800 millimetres above ground level. The body 16 has a width less than a diameter of the utility pole 14 in order to reduce its footprint and not add distance to the overall width of the utility pole 14 and the body 16 in the illustrated embodiment. However, it will be understood that the body 16 may be of any suitable shape and may be wider than the diameter of the utility pole 14 in embodiments not illustrated.

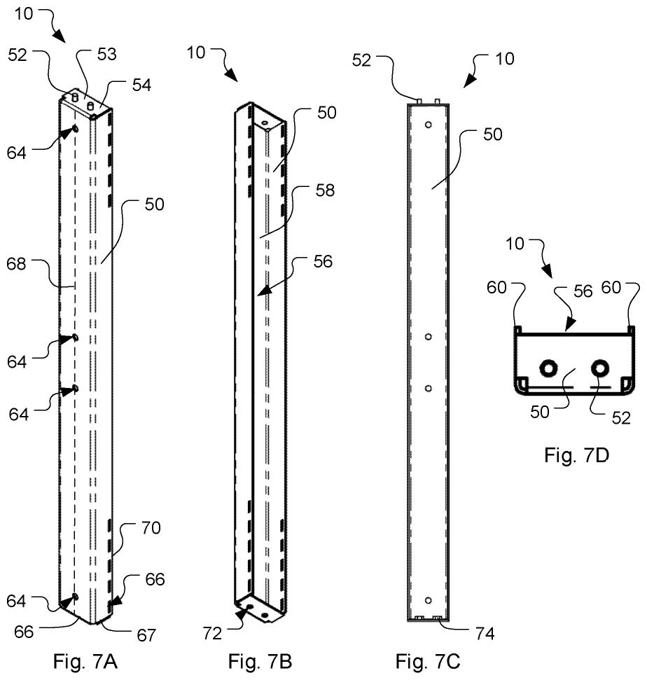

In some embodiments, the charging system 10 further comprises a mounting bracket 50 mountable to the utility pole 14, and the body 16 is mountable to the mounting bracket 50 for mounting the body 16 to the utility pole 14 (FIGS. 7A-7D). The mounting bracket 50 comprises a pair of spaced pins 52 extending away from an operatively top portion 54 of the mounting bracket 50. In particular, the pair of spaced pins 52 are disposed at a first end 53 of the mounting bracket 52 and extend in a substantially vertical direction away from the first end 53 in the illustrated embodiment. It will be understood that the mounting bracket 50 may comprise a single pin 52 in other embodiments not illustrated. For example, the mounting bracket 50 may comprise a single, substantially centrally disposed pin 52 on the first end 53 extending away from the first end 53, which may have a greater thickness than each of the illustrated pair of pins 52. In other embodiments not illustrated, the mounting bracket 50 may alternatively comprise more than two pins.

The mounting bracket 50 is elongate in the illustrated embodiment, and a width of the mounting bracket 50 is less than a width of the body 16 in order for the mounting bracket 50 to be able to be hidden or obscured by the body 16 when the body 16 is mounted on mounting bracket 50. A length of the body 16 is also less than a length of the mounting bracket 50 in the illustrated embodiment.

The mounting bracket 50 further comprises a recessed portion 56 such that the mounting bracket 50 is configured to contact the utility pole 14 at two spaced portions of the utility pole 14. As clearly shown in FIG. 7D, a rear portion 58 of the mounting bracket 50 comprises a pair of spaced contact portions 60 formed by the recessed portion 56 for contacting the utility pole 14 at the two spaced portions. The mounting bracket 50 contacting the utility pole 14 at the two spaced portions provides two contact points for stability and reduced rocking of the mounting bracket 50 on a curved surface 62 of the utility pole 14 as opposed to a single contact point. A single contact point may provide reduced stability and the increased potential for rocking of the mounting bracket 50 on the curved surface 62 of the utility pole 14, which may be provided by a non-illustrated embodiment of the mounting bracket 50 having a flat rear portion 58.

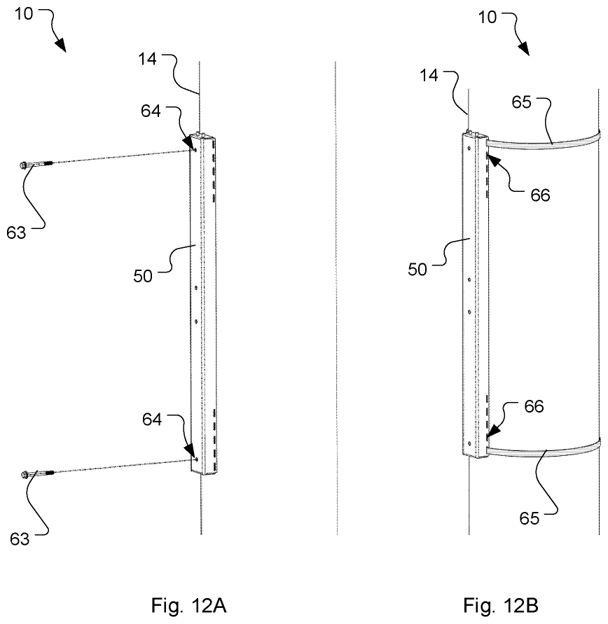

In some embodiments, the mounting bracket 50 defines holes 64 between the first end 53 and a second end 66 at an operatively bottom portion 67 of the mounting bracket 50 proximate a longitudinal axis 68 of the mounting bracket 50 for fastening the mounting bracket 50 to the utility pole 14 using screws 63 received in the holes 64 (FIG. 12A). The mounting bracket 50 defines slots 66 proximate a periphery 70 at the ends 54, 66 of the mounting bracket 50 for fastening the mounting bracket 50 to the utility pole 14 using an elongate, flexible fastener 65 such as a chain, a string, a rope, a cable tie, or the like (FIG. 12B). The mounting bracket 50 also defines a pair of holes 72 at the second end 66 and comprises a pair of locking nuts 74 in register with the pair of holes 72 and formed on an inner surface 57 of the recessed portion 56. The pair of holes 72 and the pair of locking nuts 74 are configured to receive screws 73 via holes 75 defined in an operatively bottom portion 96 of the body 16 to fasten the body 16 to the mounting bracket 50.

The body 16 defines a pair of spaced receptacles 76 proximate an operatively top portion 78 of the body 16 for receiving the pair of pins 52 to mount the body 16 to the mounting bracket 50. In the illustrated embodiment, the receptacles 76 are defined in an operatively rear portion 80 of the body 16 such that the body 16 can be mounted to the mounting bracket 50 via the rear portion 80. In some embodiments, the pair of pins 52 of the mounting bracket 50 and the pair of receptacles 76 of the body 16 are configured such that a total mass of the body 16 is supportable by the mounting bracket 50 when the pair of pins 52 are received in the pair of receptacles 76. It will be understood that in embodiments not illustrated, the body 16 may define a single receptacle 78 to receive a single pin 52.

In some embodiments, the charging system 10 further comprises a pair of panels 82 connectable to the body 16, each of the pair of panels 82 comprising a series of vents 84 for providing ventilation to the power module 18 and the charging module 22. The pair of panels 82 are connectable to a respective side portion 46, 47 of the body 16 by positioning the panels 82 such that holes 88 defined in a top portion 90 and a bottom portion 92 of the panels 82 are in register with threaded holes 94 defined in the top 78 and the bottom portion 96 of the body 16 and inserting screws 98 into the holes 88 and the threaded holes 94. In this way, the panels 82 are removably connectable to the body 16, though it will be understood that the panels 82 may be integrally formed with the body 16 in other embodiments.

The vents 84 are arranged to prevent or at least reduce water ingress into the body 16 by arranging the vents 84 to be defined in an inwardly extending side portion 100 and the bottom portion 92 of the pair of panels 82 in the illustrated embodiment. In particular, the vents 84 being short and narrow for minimal exposure of the internal components of the body 16, as well as the vents 84 not being arranged on a surface receiving rain in a perpendicular direction, prevents or reduces water ingress into the body 16. In addition, the diagonal arrangement of the vents 84 promote the flow of water downwards and away from the vents 84. This arrangement also allows the vents 84 to be hidden from an operatively front view of the body 16.

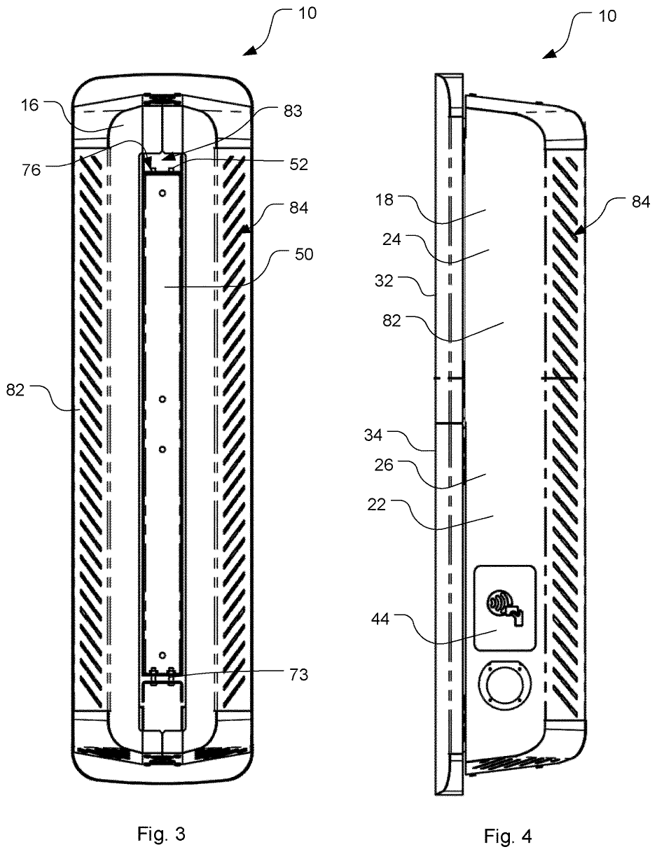

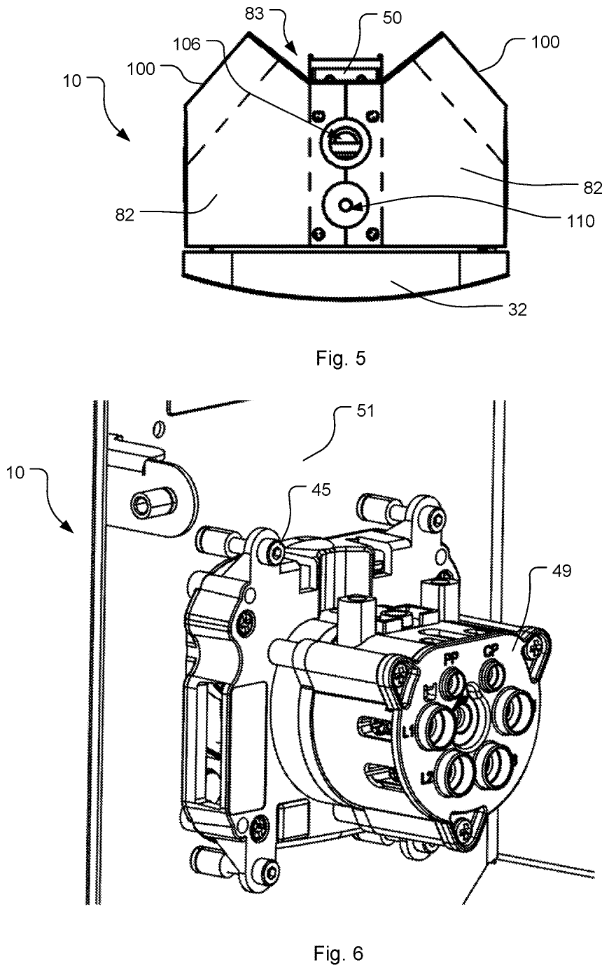

As best shown in FIGS. 4 and 5, the pair of panels 82 are arranged and/or shaped to obscure the mounting bracket 50 by being configured to extend about a portion of the utility pole 14. In other words, the panels 82 stand proud on either side of the mounting bracket 50 in an operatively rearward direction to obscure the mounting bracket 50 by forming a cavity 83 on the rear portion 80 of the body 16 (FIG. 3). The obscuring of the mounting bracket 50 provides for an improved aesthetic and discourages theft of the charging system 10 by hiding components which may be used to unmount the body 16 from the utility pole 14. In the illustrated embodiments, the panels 82 also cover the screws 73 fastening the body 16 to the mounting bracket 50, thereby deterring potential thieves from unmounting the body 16 from the mounting bracket 50.

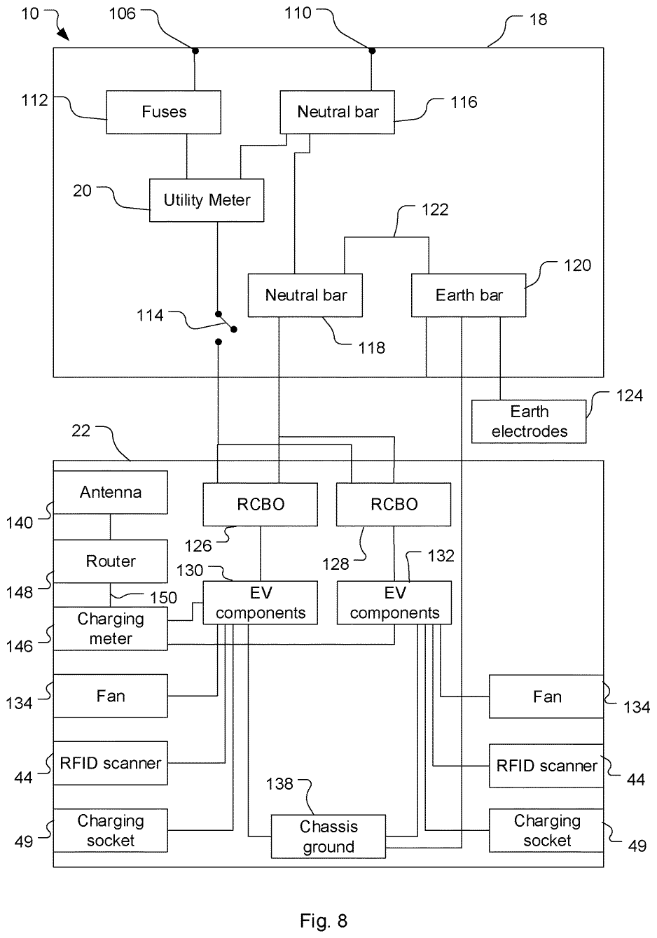

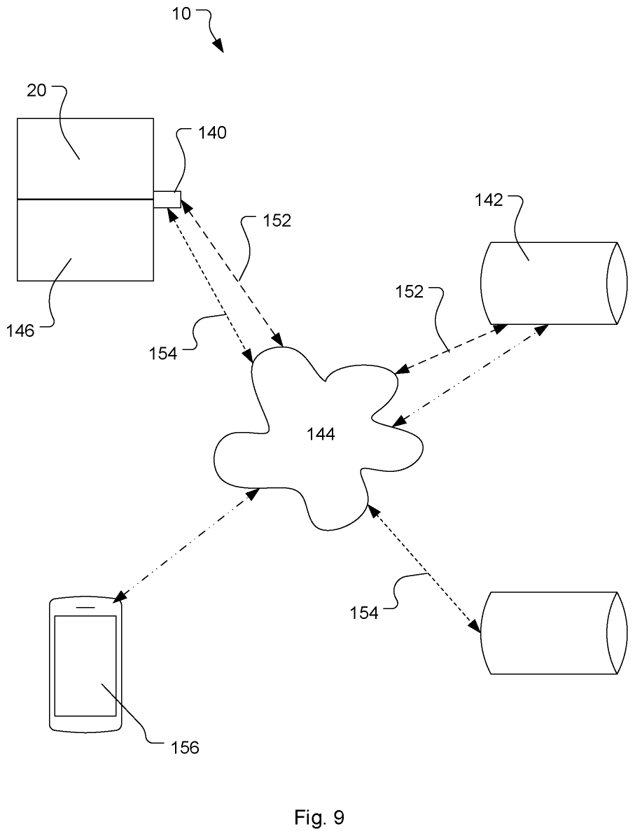

FIG. 8 shows an electrical schematic of the components of the charging system 10. In this embodiment, the power supply of the utility pole 14 comprises a three-phase AC power supply, and the charging module 22 is operable to provide three-phase AC power received from the power module 18 to the device.

With respect to the power module 18, the three-phase AC power supply is connected to the charging system 10 by connecting a power cable 104 of the utility pole 14 to a power input 106 disposed on the top portion 78 of the body 16. A neutral cable (not shown) is also connected to a neutral input 110 disposed on the top portion 78 of the body 16. The power input 106 is connected to a set of fuses 112 and the set of fuses 112 is connected to the utility meter 20 which is connected to the charging module 22 via a switch 114. The neutral input 110 is connected to a first neutral bar 116 which is connected to the utility meter 20 and a second neutral bar 118. The second neutral bar 118 is connected to the power module 22 and to an earth bar 120 via a multiple earthed neutral (MEN) connection 122, and the earth bar 120 is connected to earth electrodes 124 and the body 16.

With respect to the charging module 22, the utility meter 20 is connected to a first residual current circuit breaker with overcurrent protection (RCBO) 126 via the switch 114, and the first RCBO 126 is connected to a second RCBO 128. The second neutral bar 118 of the power module 18 is also connected to the first and second RCBOs 126, 128. In the illustrated embodiment, each RCBO 126, 128 is connected to a respective set of electric vehicle charging components 130, 132 for charging an electric vehicle. Each of the sets of electric vehicle charging components 130, 132 includes a current transformer, relays, a programmable logic controller (PLC), a contactor, and other relevant electric vehicle charging components known to the person skilled in the art. Each set of electric vehicle charging components 130, 132 is connected to a fan 134, one of the RFID readers 44, and the electric vehicle charging socket 49 accessible via the through hole 48 of the respective side portion 46, 47 of the body 16. The sets of electric vehicle charging components 130, 132 are each also connected to a chassis ground 138, which is also connected to the earth bar 120 of the power module 18.

The charging system 10 further comprises an antenna 140 mounted on an external surface 136 of the body 16, the antenna 140 being in communication with the charging module 22 for communication between the charging module 22 and a server 142 via a wide area network 144, which will be discussed in more detail below. In particular, the charging module 22 further comprises a charging meter 146 for measuring power provided by the charging module 22 to the electric vehicle and is connected to each set of electric vehicle charging components 130, 132. The charging meter 146 is connected to the antenna 140 via a router 148 connected to the charging meter 146 via a local area network connection 150. It is noted that the antenna 140 is not shown in the figures illustrating the body 16, i.e. FIGS. 1-6 and 12A-15.

The antenna 140 is also in communication with the utility meter 20 of the power module 18 for communication between the utility meter 20 and the operator of the utility meter 20 via the wide area network 144.

It will be understood that in some embodiments, components of the power module 18 are connected to components of the charging module 22 via wiring passing through the through holes 30 of the plate 28 separating the first portion 24 carrying the power module 18 and the second portion 26 carrying the charging module 22. It will also be understood that the charging system 10 is able to charge two electric vehicles simultaneously, however, in other embodiments, the body 10 may only have a single through hole 48 on a single side portion 46 of the body 16 for receiving a single electric vehicle charging socket 49, and the charging module 22 may instead have a single set of electric vehicle charging components 130 connected to the charging socket 49 for charging one electric vehicle at a time. In other embodiments, the charging system 10 may include additional relevant components for charging three or more electric vehicles simultaneously.

FIG. 9 shows a network schematic of the charging system 10. The charging meter 146 is in communication with the antenna 140 for transmitting an indication 152 to the server 142 of a measure of power provided to the electric vehicle via the wide area network 144. The server 142 is in communication with a user interface via a virtual private network for accessing the charging module 22 to, for example, troubleshoot issues with respect to the sets of electric vehicle charging components 130, 132 and/or to update instructions stored on the PLC of each set of electric vehicle charging components 130, 132. In some embodiments, the server 142 is owned and/or managed and/or accessible by the operator of the charging module 22.

The utility meter 20 of the power module 18 is in communication with the antenna 140 for transmitting an indication 154 of the power consumed from the power supply by the power module 18 to the operator of the utility meter 20 via the wide area network 144. In this way, the charging system 10 allows for simultaneous communication with the operator of the utility meter 20 and the operator of the charging module 22 using components carried by and connected to the single body 16 of the charging system 10.

The charging system 10 further comprises an application installable on a user device 156 for communication between the user device 156 and the charging module 22 via the server 142 and the antenna 140 over the wide area network 144. The application is configured to effect electronic payment between a user and the operator of the charging module 22 based on the indication 152 of the measure of power provided to the device received by the server 142. For example, the operator of the charging module 22 may set a charging fee for charging the electric vehicle per hour or part thereof and the charging fee may be charged to the user via the application by communicating with the server 142 which has the user's credit card details securely stored.

The user is able to access the charging system 10 by selecting a particular charging module 22 using the application, which may be based on the user's location as determined by a global positioning system of the user device 156 accessible by the application. Once the user has selected the charging module 22 using the user device 156 running the application, the server 142 in communication with the user device 156 validates the user's identification and payment credentials and transmits an indication to the relevant set of electric vehicle charging components 130, 132 via the antenna 140 to cause the relevant set of electric vehicle charging components 130, 132 to make power available via the electric vehicle charging socket 49.

The user also has the option of accessing the charging system 10 by scanning an RFID tag (not shown) provided by the operator of the charging module 22 using one of the RFID readers 44 in order to access the charging socket 49 proximate the RFID reader 44 that was used to scan the RFID tag. A user indication is stored on the RFID tag which is transmitted to the server 142 over the wide area network 144 via the antenna 140 after being read by the RFID reader 44 in order to access the user's identification and payment credentials securely stored on the server 144 to make power available via the electric vehicle charging socket 49 and to effect payment for the power provided to the electric vehicle.

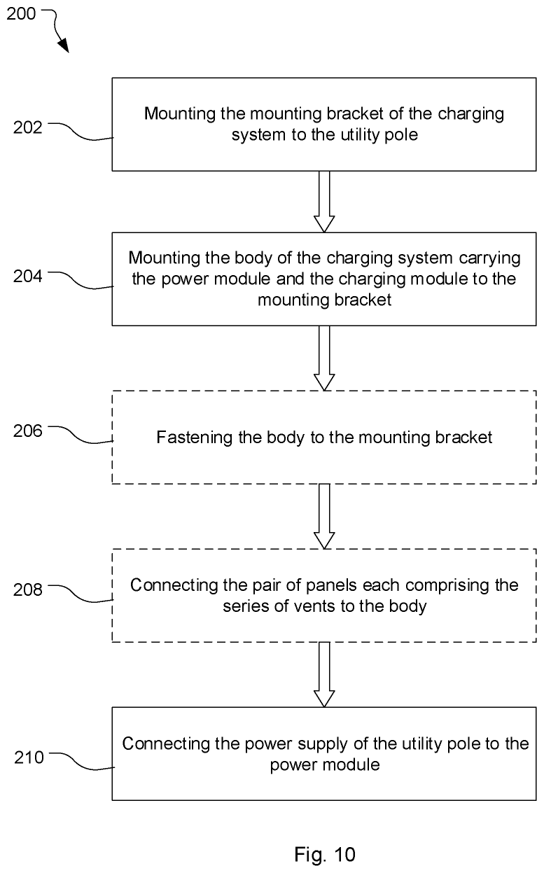

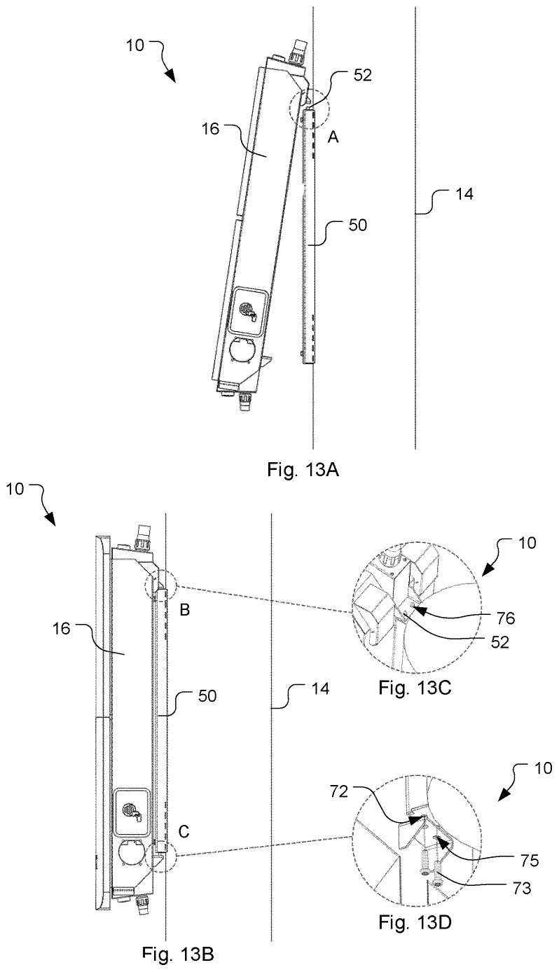

A method 200 of installing the charging system 10 for charging the device to the utility pole 14 comprising a power supply is shown in the flowchart of FIG. 10. The method 200 comprises mounting 202 the mounting bracket 50 of the charging system 10 to the utility pole 14 (FIGS. 12A-12B), and mounting 204 the body 16 of the charging system 10 carrying the power module 18 and the charging module 22 to the mounting bracket 50 by inserting the pins 52 of the mounting bracket 50 into the pair of receptacles 76 defined proximate the operatively top portion 78 of the body 16 as shown in circles A and B of FIGS. 13A and 13B, respectively. The method 200 also comprises connecting 210 the power supply of the utility pole 14 to the power module 18 of the charging system 10.

In some embodiments, the mounting 202 the mounting bracket 50 to the utility pole 14 comprises fastening the mounting bracket 50 to the utility pole 14. FIG. 12A shows an embodiment of fastening the mounting bracket 50 to the utility pole using the screws 63 received in the holes 64 defined in the mounting bracket 50. This embodiment of fastening the mounting bracket 50 to the utility pole 14 is suitable for wooden utility poles 14 which allow the screws 63 to easily penetrate the surface of the utility pole 14 using a handheld power tool. FIG. 12B shows another embodiment of fastening the mounting bracket 50 to the utility pole 14 using a cable tie 65 received in the slots 66 defined in the mounting bracket 50 and positioned about the utility pole 14. This embodiment of fastening the mounting bracket 50 to the utility pole 14 is suitable for metal utility poles 14 which do not allow the screws 63 to easily penetrate the surface of the utility pole 14 using a handheld power tool.

The mounting 204 the body 16 to the mounting bracket 50 comprises fastening 206 the body 16 to the mounting bracket 50. In particular, the fastening 206 the body 16 to the mounting bracket 50 comprises fastening the operatively bottom portion 96 of the body 16 to the operatively bottom portion 67 of the mounting bracket 50 using the screws 73 received in the holes 75 defined in the operatively bottom portion 96 of the body 16 and the holes 72 defined in the operatively bottom portion 67 of the mounting bracket 50 (FIG. 13D). It will be understood that the pins 52 of the mounting bracket 50 are configured to fully support the weight of the body 16 via the receptacles 76, allowing the body 16 to be supported while additional mounting steps are performed and allowing the installation process to be carried out more easily and efficiently.

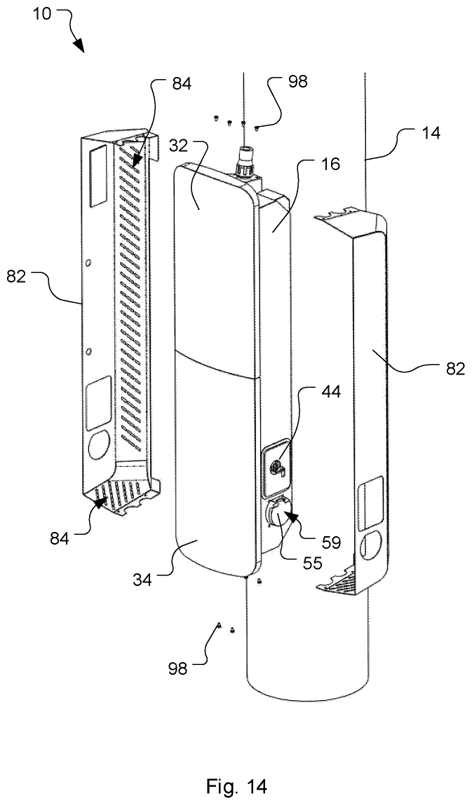

In some embodiments, the method 200 further comprises connecting 208 the pair of panels 82 of the charging system 10 to the body 16 (FIG. 14). In some embodiments, the method 200 further comprises connecting the pair of covers 32, 34 to the body 16 for covering the first portion 22 and the second portion 24 of the body 16. In other embodiments, the method 200 further comprises connecting the charging sockets 49 to the charging module 22 for providing power to the electric vehicle.

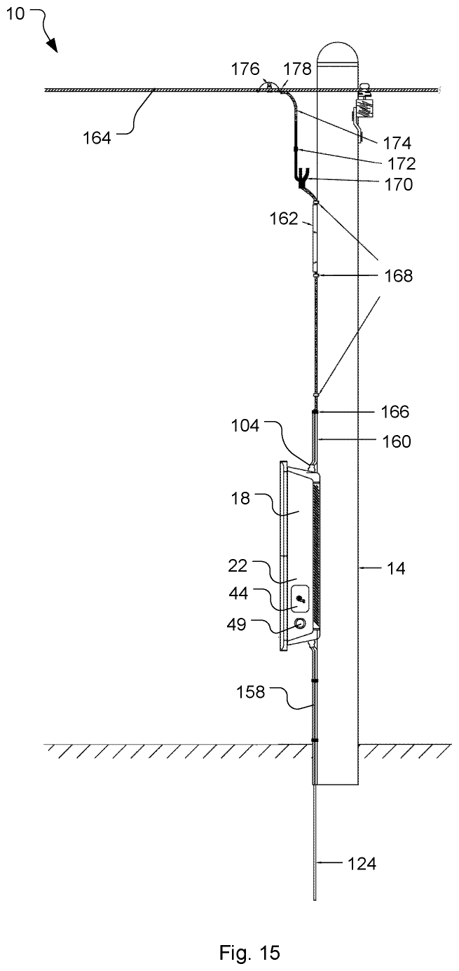

In some embodiments, the connecting 210 the power supply to the power module 18 comprises connecting the power cable 104 to the power module 18 (FIG. 15). In some embodiments, the method 200 further comprises connecting an earthing cable 158 to the charging module 22 for earthing the charging module 22 and the power module 18 via the earth electrodes 124. FIG. 15 shows the power cable 104 being protected by a cable cover 160 connected to the utility pole 14 proximate the top portion 78 of the body 16, and passing through a flexible conduit 162 proximate a power line 164 of the utility pole 14. A cable saddle 166 and cable clamps 168 are used to provide additional support for the power cable 104 against the utility pole 14. A heat shrink termination kit 170, a crimp link 172, and an insulated cable 174 connect the power cable 104 to the power line 164 via tap-off connectors 176 and a UV stabilised cable tie 178.

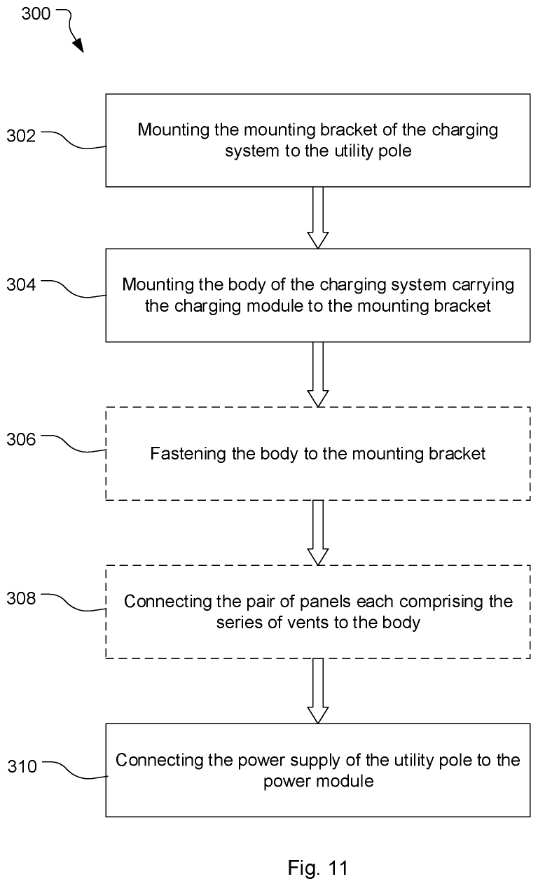

FIG. 11 shows a flowchart of another embodiment of a method 300 of installing the charging system 10 for charging a device to the utility pole 14 comprising a power supply. The method 300 comprises mounting 302 the mounting bracket 50 of the charging system 10 to the utility pole 14, and mounting 304 the body 16 of the charging system 10 carrying the charging module 22 to the utility pole 14 by inserting the pins 52 of the mounting bracket 50 into the pair of receptacles 76 defined proximate the operatively top portion 78 of the body 16. The method 300 further comprises connecting 310 the power supply of the utility pole 14 to the charging module 22 of the charging system 10. In some embodiments. the method 300 may also comprise fastening 306 the body 16 to the mounting bracket 50 and connecting 308 the pair of panels 82 of the charging system 10 to the body 16 in the same manner as discussed above.

It will be understood that the charging system 10 used in the method 300 includes the mounting bracket 50, though does not include the power module 18 being carried by the body 16. Instead, the power module 18 may be provided as a separate component (not shown) to the body 16 and attached separately to the utility pole 14 with wires connecting the separate component to the charging module 22. It will also be understood that the embodiment of the charging system 10 not including the power module 18 can be combined with any of the features discussed in this specification with respect to the embodiment of the charging system 10 including the power module 18.

In use, the user parks their electric vehicle near the charging system 10 mounted to the utility pole 14. The user accesses the application installed on their user device 156 to connect the user device 156 to the server 142 via the wide area network 144 in order to confirm the user's credentials and for the server 142 to communicate with the charging system 10 via the antenna 140 to allow power to be provided via the charging socket 49. Alternatively, the user positions their RFID tag near the RFID reader 44 to scan the RFID tag and transmit a user indication stored on the RFID tag to the server 142 via the antenna 140 and the wide area network 144 in order for the server 142 to allow power to be provided via the charging socket 49.

The user inserts a charging cable provided by the user into the charging socket 49 to charge their electric vehicle's battery for as long as the user requires. The user removes the cable from the charging socket 49 which defines the conclusion of the charging session, and the user is charged for the power used by the server 142 via the user's payment details securely stored by the server 142.

The charging system 10 is able to be retrofitted to existing street-side utility poles 14, thereby providing more charging stations in more locations for electric vehicle owners and reducing the travel time for the electric vehicle owners to their nearest charging station. The embodiment of the charging module 22 having two sets of electric vehicle charging components 130, 132 and providing two electric vehicle charging sockets 49 allows for two electric vehicles to park near the same utility pole 14 and use the same charging system 10, thereby reducing user wait times and increasing user convenience.

The combination of the power module 18 with the utility meter 20 and the charging module 22 in a single unit provides a smaller and more aesthetically pleasing solution as opposed to installing a switchboard as a separate unit proximate the charging system 10 on the utility pole 14. Further, the power module 18 is located at a safe distance from the ground as the technician does not require a ladder to access the power module 18.

The pins 52 of the mounting bracket 50 provides ease of installation by allowing a technician to support the weight of the body 16 via the pins 52 and the receptacles 76 defined in the body 16 while the technician applies the screws 73 through the holes 75 defined in the operatively bottom portion 96 of the body 16 and the holes 72 defined in the operatively bottom portion 67 of the mounting bracket 50 to fasten the body 16 to the mounting bracket 50. The recessed portion 56 of the mounting bracket 50 provides two spaced contacting portions of the bracket 50 on the utility pole 14 in use, thereby providing increased support compared to a single contacting portion of the utility pole 14 being used to support the mounting bracket 50.

The embodiment of the mounting bracket 50 being elongate and narrower than the body 16 contributes to the mounting bracket 50 being obscured at least from a front view of the charging system 10, thereby increasing the aesthetic appeal of the charging system 10. The obscuring of the mounting bracket 50 also discourages theft of the charging system 10 by hiding components which may be used to unmount the body 16 from the utility pole 14.

The series of vents 84 of the panels 82 allow for ventilation of the power module 18 and the charging module 22, which contributes to the safety of the charging system 10 by reducing the prevalence of overheating of the electrical components of the power module 18 and the charging module 22. This ventilation therefore increases the safety of having the power module 18 and the charging module 22 being carried by the single body 16, which generate more heat in use per unit of volume that requires dispersing compared to providing the charging module 22 separate to the power module 18. Such separate power modules or switchboards are typically approximately 600 millimetres wide and 600 millimetres long, as opposed to the power module 18 of the charging system 10, which has a typical width of between about 250 millimetres and about 400 millimetres and a typical length of between about 350 millimetres and about 650 millimetres. This reduced overall size of the power module 18 compared to typically available switchboards generates more heat per unit of volume that requires dispersing compared to that of typically available switchboards. In addition, the fans 134 of the charging module 22 further support the ventilation provided by the series of vents 84.

The separate covers 32, 34 for the first and second portions 22, 24, respectively, allow for increased security by due to each cover 32, 34 being lockable and therefore the power module 18 and the charging module 22 may be accessible by a different designated person or people. For example, the power module 18 may only be accessible by the operator of the utility meter 20 and the charging module 22 may only be accessible by the operator of the charging module 22. This reduces the prevalence of unauthorised access to the power module 18 and/or the charging module 22 compared to an embodiment whereby any technician with a single key is able to access both the power module 18 and the charging module 22.

The embodiment of the charging system 10 whereby the mounting bracket 50, the body 16, the panels 82, the covers 32, 34, and/or the charging sockets 49 are separate or modular components provides a reduction in the individual weight of the components of the charging system 10, thereby allowing for an easier installation by the technician compared to an embodiment whereby two or more of the above components are integrally formed. For example, by mounting the relatively lightweight mounting bracket 50 to the utility pole 14 and then mounting the body 16 to the mounting bracket 50 such that the weight of the body 16 is fully supported by the mounting bracket 50, there is no point during the installation whereby the technician is required to support the weight of the body 16 while mounting the body 16 to the utility pole 14. This modular installation of the charging system 10 therefore allows the charging system 10 to be installed by a single technician, rather than having a first technician support the weight of the body 16 while a second technician mounts the body 16 to the utility pole 14. The modular components also allow for ease of replacement if one or more of the components are vandalised or damaged.

The elongate embodiment of the body 16 may deter vandals from climbing the body 16 as there are no gripping points on the body 16 and climbing an elongate structure is more challenging than climbing a body having a shorter, wider structure, especially having a profile wider than the diameter of the utility pole 14. The panels 82 also cover the screws 73 fastening the body 16 to the mounting bracket 50 in some embodiments, thereby deterring potential thieves from unmounting the body 16 from the mounting bracket 50.

It will be appreciated that the mounting bracket 50 may be provided as a standalone product, rather than being a part of the charging system 10.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A charging system for charging a device via a utility pole, the utility pole comprising a power supply, the charging system comprising:
a body mountable to the utility pole;
a power module carried by the body and connectable to the power supply of the utility pole, the power module having a utility meter for measuring power consumed by the power module from the power supply; and
a charging module carried by the body and in electrical communication with the power module, the charging module being operable to provide power received from the power module to the device.

2. The charging system of claim 1, further comprising a mounting bracket mountable to the utility pole, wherein the body is mountable to the mounting bracket for mounting the body to the utility pole.

3. The charging system of claim 2, wherein the mounting bracket comprises at least one pin extending away from an operatively top portion of the mounting bracket, and wherein the body defines at least one receptacle proximate an operatively top portion of the body for receiving the at least one pin to mount the body to the mounting bracket.

4. The charging system of claim 3, wherein the at least one receptacle is defined in an operatively rear portion of the body.

5. The charging system of claim 3, wherein the at least one pin of the mounting bracket and the at least one receptacle of the body are configured such that a total mass of the body is supportable by the mounting bracket when the at least one pin is received in the at least one receptacle.

6. The charging system of claim 3, wherein the mounting bracket comprises a pair of spaced pins extending away from the operatively top portion of the mounting bracket, and wherein the body defines a pair of spaced receptacles proximate the operatively top portion of the body for receiving the pair of pins to mount the body to the mounting bracket.

7. The charging system of any one of claim 2, wherein the mounting bracket comprises a recessed portion such that the mounting bracket is configured to contact the utility pole at two spaced portions of the utility pole.

8. The charging system of claim 2, wherein the body and the mounting bracket are elongate.

9. The charging system of claim 2, wherein a width of the mounting bracket is less than a width the body.

10. The charging system of claim 1, further comprising a pair of panels connectable to the body, each of the pair of panels comprising a series of vents for providing ventilation to the power module and the charging module.

11. The charging system of claim 10, wherein the vents are arranged to prevent water ingress into the body.

12. The charging system of claim 10, wherein the vents are arranged such that the vents are hidden from an operatively front view of the body.

13. The charging system of claim 10, wherein the pair of panels are removably connectable to the body.

14. The charging system of claim 1, further comprising a mounting bracket mountable to the utility pole, wherein the body is mountable to the mounting bracket for mounting the body to the utility pole, and wherein the pair of panels are arranged to obscure the mounting bracket.

15. The charging system of claim 14, wherein each panel is configured to extend about a portion of the utility pole to obscure the mounting bracket.

16-19. (canceled)

20. The charging system of claim 1, wherein the body comprises a first portion and a second portion spaced from the first portion, wherein the first portion carries the power module and the second portion carries the charging module, and wherein the first portion and the second portion are spaced by a plate defining at least one through hole for connecting the charging module to the power module.

21. (canceled)

22. The charging system of claim 20, further comprising a pair of covers connectable to the body for covering the first portion and the second portion, and wherein the covers are hingedly connectable to the body.

23. The charging system of claim 22, wherein the covers are hingedly connectable to the body.

24-26. (canceled)

27. The charging system of claim 1, further comprising at least one charging socket for providing power to the device, wherein the device is an electric vehicle, and wherein the at least one charging socket is operable to provide power to the electric vehicle.

28-38. (canceled)

39. A charging system for charging a device via a utility pole, the utility pole comprising a power supply, the charging system comprising:
a mounting bracket mountable to the utility pole, the mounting bracket comprising at least one pin extending away from an operatively top portion of the mounting bracket;
a body mountable to the mounting bracket and defining at least one receptacle proximate an operatively top portion of the body, the body being mountable to the mounting bracket by insertion of the at least one pin of the mounting bracket into the at least one receptacle; and
a charging module carried by the body and connectable to the power supply of the utility pole, the charging module being operable to provide power received from the power supply to the device.

40-41. (canceled)
